(19) United States
(12) Patent Application Publication
(10) Pub. No.: US 2003/0151506 A1
(43) Pub. Date: Aug. 14, 2003

(54) Method and apparatus for locating missing persons

(76) Inventor: Mark Luccketti, Middletown, NY (US)

Correspondence Address: BAKER & BOTTS, 30 ROCKEFELLER PLAZA, NEW YORK, NY, 10112

(21) Appl. No.: 10/073,454

(22) Filed: Feb. 11, 2002

(51) Int. Cl. G08B 1/08

(52) U.S. Cl. 340/539.13; 340/995.1

(57) ABSTRACT

A system for locating a person including a mobile transmitter removably secured to the person and a portable monitoring unit carried by a user monitoring the location of the person. The mobile transmitter receives GPS ranging signals from GPS satellites. Each of the GPS ranging signals includes an offset proportional to the distance of the mobile transmitter from the respective GPS satellite broadcasting the GPS ranging signal. The GPS ranging signals, including the respective offsets, are transmitted to the portable monitoring unit. The portable monitoring unit comprises a GPS circuit which determines the location of the mobile transmitter based on the GPS ranging signals received by the mobile transmitter, and superimposes the location of the mobile transmitter on a map displayed on the portable monitoring unit.

### BACKGROUND

1. Field of the Invention

This invention relates to personal monitoring and locating systems using incorporating Global Positioning System (GPS) technology, and more particularly to a system including a portable transmitting unit worn by an individual that receives GPS ranging signals from the GPS satellite and relays them to a portable monitoring unit which determines the location of the portable transmitting unit with GPS and displays the location on a display screen on the portable monitoring unit.

2. Background of the Related Art

There has been increasing demand for systems which allow parents to monitor the location of their children, particularly in public places. Such systems are also useful for tracking other individuals, such as Alzheimer's patient, who may become disoriented or lost. If the child or the patient becomes separated from the parent, several systems have been developed to assist the parent in locating the child.

For example, U.S. Pat. No. 5,748,087 to Ingargiola et al. describes a system having a receiver worn by a child or an Alzheimer's patient and a transmitter carried by a parent or a guardian. The parent or guardian may use the transmitter to emit a “find” signal if the child or patient is missing. Upon receipt of the “find” signal, the receiver generates an auditory alarm via speakers and a visual alarm via illuminated LED's.

A disadvantage of such a system is that the receiver does not provide location coordinates of the child or patient to the parent or guardian. Consequently, the parent or guardian is required to be within audible or visual range of the alarm in order to locate the child or patient. This process of locating the source of the alarm may be especially difficult in locations having large crowds and a high level of ambient noise or bright lighting.

GPS technology has been used by other systems to provide the location coordinates of the child to the parent or guardian. For example, U.S. Pat. No. 5,742,233 to Hoffman et al., U.S. Pat. No. 6,031,460 to Banks, U.S. Pat. No. 6,014,080 to Layson, and U.S. Pat. No. 5,731,785 to Lemelson et al. describe systems which include a portable GPS receiver for use with a mobile subject such as a child, patient, criminal offender, or a vehicle. The portable GPS receiver receives GPS ranging signals from the GPS satellites and determines its location coordinates from these signals. The GPS receiver then transmits its location coordinates to a central station. The central station makes the location coordinates available to individuals that are interested in locating the child, patient, criminal offender, vehicle, etc.

The GPS systems described herein overcome some of the limitations of the '087 system by providing the child's location coordinates. However, there are several shortcomings that are not addressed by the GPS systems known in the art. For example, the calculation of the child's location is performed by a GPS circuit provided in the remote device worn by the child. Providing the capability of determining location in the device worn by the child introduces additional complexity and weight. This additional bulk is especially undesirable when the GPS receiver circuit is worn by a small child.

An additional shortcoming of known systems is the inconvenience of relaying the child's coordinates to a central tracking station. In many instances when a child is likely to become separated from the parent, both the child and the parent are away from home, and therefore typically do not have access to a home computer and/or detailed maps with latitude and longitude coordinates. Without access to such detailed maps, the parent may be unable to relate the child's coordinates, which are provided by the central tracking station, to recognizable geographical features, such as local streets or buildings.

There exists a need to provide the coordinates of a lost child to a parent that includes a lightweight transmitter worn by the child and a portable monitoring unit carried by the parent, in which the location of the child is calculated and superimposed on detailed maps displayed on the portable monitoring unit that a parent can carry with them at all times.

It is an object of the invention to provide a system for monitoring a child's location including a mobile transmitter worn by the child which relays the GPS ranging signals to the portable monitoring unit carried by the parent.

It is another object of the invention to provide a system for monitoring a child's location including a portable monitoring unit carried by the parent which receives the GPS ranging signals from the mobile transmitter worn by the child, and which portable monitoring unit determines the location of the mobile transmitter by use of the GPS ranging signals and standard GPS techniques.

It is a further object of the invention to provide a system which displays the child's location on the portable monitoring unit, with the child's location superimposed on a detailed local map.

### SUMMARY OF THE INVENTION

These and other objects of the invention, which will become apparent with respect to the disclosure herein, are accomplished by a system for monitoring the location of a person, comprising a mobile transmitter configured to be removably secured to the person. The mobile transmitter comprises a GPS antenna and a GPS receiver circuit configured to receive a plurality of GPS ranging signals from GPS satellites. The mobile transmitter also comprises a first transceiver and a first antenna configured to re-transmit the GPS ranging signals.

A portable monitoring unit is also provided which comprises a portable case, a second transceiver and a second antenna configured to receive the re-transmitted GPS ranging signals from the mobile transmitter. A GPS receiver circuit is configured to receive GPS ranging signals from the mobile transmitter and to determine the location of the mobile transmitter. A display screen is provided on the portable monitoring unit to superimpose the location of the mobile transmitter on a local area map.

According to one embodiment, the first antenna and the first transceiver of the mobile transmitter and the second antenna and the second transceiver of the portable monitoring unit are configured to operate on a radio frequency, and the re-transmitted GPS ranging signals are transmitted on a radio frequency.

Advantageously, the portable monitoring unit further comprises a panic button, which actuates the second transceiver and the second antenna to broadcast a second radio frequency signal to the mobile transmitter. The mobile transmitter may also comprise a speaker that is configured to produce a high-decibel sound when the second radio frequency signal is received by the first antenna and the first transceiver.

According to another embodiment, the first antenna and the first transceiver of the mobile transmitter, and the second antenna and the second transceiver of the portable monitoring unit are configured to operate on a cellular telephone network, and the GPS ranging signals are re-transmitted on the cellular telephone network.

In accordance with this embodiment, the mobile transmitter may further comprise a third transceiver, a third antenna, and a speaker, and the portable monitoring unit may further comprise a fourth transceiver, a fourth antenna, and an input switch, which actuates the fourth transceiver and the fourth antenna to broadcast a radio frequency signal to the mobile transmitter. The speaker is configured to produce a high-decibel sound when the radio frequency signal is received by the third antenna and the third transceiver.

According to a further embodiment, the mobile transmitter further comprises a memory unit storing a first identification code, and the portable monitoring unit comprises a memory unit storing a second identification code. The second transceiver and the second antenna are configured to transmit a request signal comprising the second identification code. The first transceiver and the first antenna are configured to receive the request signal comprising the second identification code and to re-transmit the GPS ranging signals to the portable monitoring unit if the first identification code matches the second identification code.

In accordance with the invention, the objects as described above have been met, and the need in the art for a system which provide the coordinates of a lost child to a parent that includes a lightweight transmitter worn by the child and a portable monitoring unit carried by the parent in which the location of the child is superimposed on detailed maps has been satisfied. Further features of the invention, its nature and various advantages will be more apparent from the accompanying drawings and the following detailed description of illustrative embodiments.

### BRIEF DESCRIPTION OF THE DRAWINGS

FIG. 1 is a simplified schematic view of the system in accordance with the invention.

FIG. 2 is a simplified view of a mobile transmitter in accordance with the invention.

FIG. 3 is simplified block diagram of the mobile transmitter illustrated in FIG. 2 in accordance with the invention.

FIG. 4 is a simplified view of a portable monitoring unit in accordance with the invention.

FIG. 5 is a perspective view of the portable monitoring unit of FIG. 4 in accordance with the invention.

FIG. 6 is a simplified block diagram of the portable unit of FIG. 4 in accordance with the invention.

FIG. 7 is another embodiment of the mobile transmitter illustrated in FIG. 3 in accordance with the invention.

FIG. 8 is another embodiment of the portable unit of FIG. 6 in accordance with the invention.

### DETAILED DESCRIPTION OF THE EXEMPLARY EMBODIMENTS

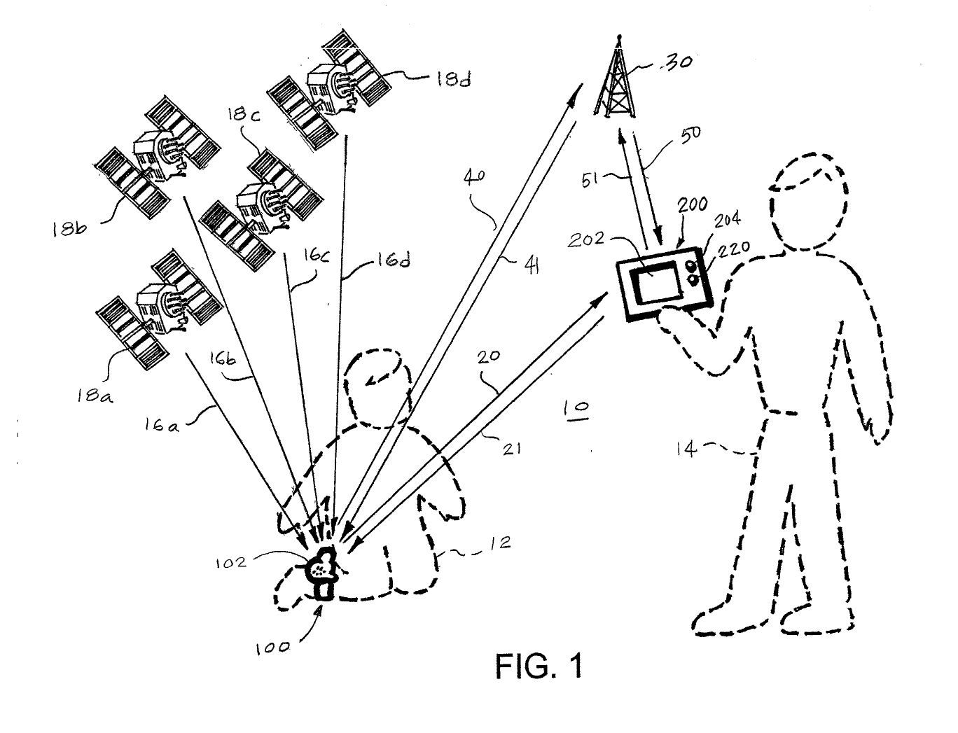

The system in accordance with the invention is illustrated in FIG. 1, and generally denoted by reference number 10. A portable, mobile transmitter 100 is removably secured to the subject 12 being monitored, for example, a young child. A portable monitoring unit 200 is carried by or otherwise maintained in the vicinity of a user 14, such as a parent or a guardian, who is monitoring the location of the subject 12. In the exemplary embodiment, GPS technology is used, which includes a constellation of at least 24 satellites, also referred to as space vehicles (SV's), that are distributed over the earth such that at least four SV's are visible at any location on the earth's surface. As illustrated in FIG. 1, the SV's 18a, 18b, 18c, 18d transmit microwave ranging signals 16a, 16b, 16c, 16d, which are received by the mobile transmitter 100. The ranging signals 16a, 16b, 16c, 16d include an L-band signal modulated with a Pseudorandom Noise (PRN) Code known as the “C/A code sequence.” The C/A code sequence repeats each millisecond and has a unique PRN code for each of the 24 SV's orbiting the earth. The ranging signals 16a, 16b, 16c, 16d also contain a navigation message, which is a 50 Hz signal that provides data to support the position determination process. The navigation message consists of time-tagged data bits used to determine, e.g., satellite time of transmission, satellite position, satellite clock correction, and other system parameters.

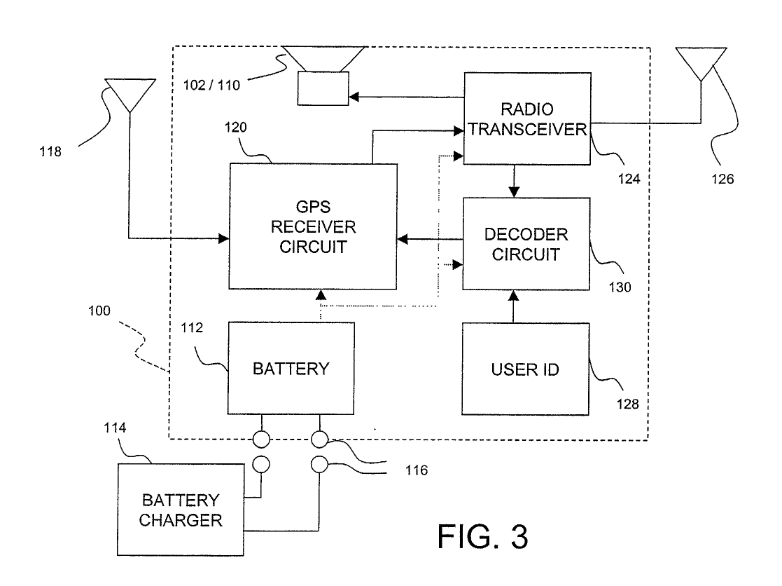

The mobile transmitter 100 receives the ranging signals 16a, 16b, 16c, 16d from three to four SV's 18a, 18b, 18c, 18d with a GPS antenna 118 (see FIG. 3). The ranging signals of all of the GPS SV's are synchronized to a reference time, i.e., “GPS time.” The amount of time it takes for each ranging signal 16a, 16b, 16c, 16d to arrive at the mobile transmitter 100 is indicative of the distance of the transmitting SV 18a, 18b, 18c, 18d from the mobile transmitter 100. Each ranging signal 16a, 16b, 16c, 16d will implicitly have an offset (delay) from GPS time that is proportional to the distance traveled by the ranging signal 16a, 16b, 16c, 16d. The mobile transmitter 100 includes a GPS receiver circuit 120 (see FIG. 3) which identifies the ranging signals 16a, 16b, 16c, 16d. The mobile transmitter 100 then re-transmits the ranging signals to the portable monitoring unit 200. (Communications from the mobile transmitter 100 to the portable monitoring unit 200 are illustrated generally by reference number 20.) The GPS ranging signals which are transmitted from the mobile transmitter 100 to the portable monitoring unit 200 may be referred to as “re-transmitted GPS ranging signals.”

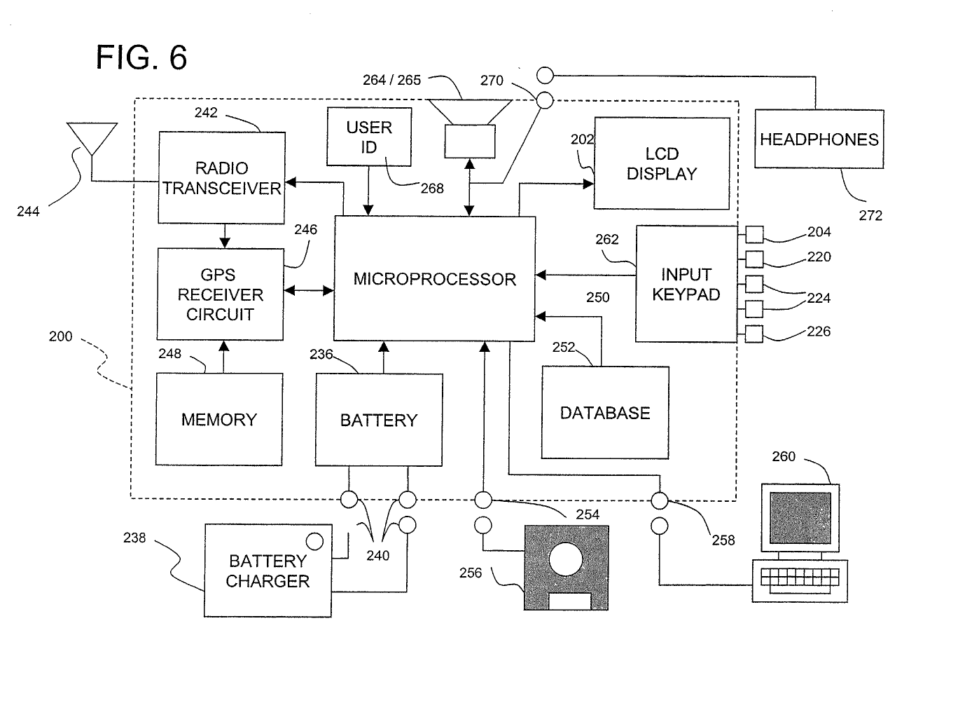

The portable monitoring unit 200 receives the ranging signals 16a, 16b, 16c, 16d from the mobile transmitter 100. A GPS receiver circuit 246 (see FIG. 6) receives the ranging signals 16a, 16b, 16c, 16d and generates a reference C/A code signal which is also synchronized to GPS time. As described above, each ranging signal implicitly contains an delay proportional to the distance of the respective SV 18a, 18b, 18c, 18d from the mobile transmitter 100, which originally received the ranging signals 16a, 16b, 16c, 16d. The GPS receiver circuit 246 then determines the offset (delay) between the reference code signal generated by the GPS receiver circuit 246 and the code signal in the ranging signal 16a, 16b, 16c, 16d as received by mobile transmitter 100. This offset is referred to as the Time of Arrival (“TOA”) or the “pseudo-range,” since corrections, such as atmospheric effects, need to be made to this value to determine the actual range, as is well known in the art.

The location of all 24 SV's in operation is known to the GPS receiver circuit 246, as this information is periodically transmitted by the SV's in the ranging signals. The use of trilateration, as is known in standard GPS technology, allows the GPS receiver circuit 246 to determine the geographical location of the mobile transmitter 100 once the locations and distances of SV's 18a, 18b, 18c, 18d have been determined. (It is noted that system 10 operates in a substantially identical manner with other, similar ranging systems, such as GLONASS, which use signals from a plurality of SV's to determine geographical location.)

In the exemplary embodiment, the mobile transmitter 100 continuously receives the carrier signals 16a, 16b, 16c, 16d from the SV's 18a, 18b, 18c, 18d. The portable monitoring unit 200 allows the user 14 to locate the mobile transmitter 100 (and consequently, the subject 12) by sending a request signal including a unique user ID code to the mobile transmitter 100. (Communications from the portable monitoring unit 200 to the mobile transmitter 100 are illustrated generally by reference number 21.) The mobile transmitter 100 receives the request signal from the portable monitoring unit 200, and determines whether the unique user ID code transmitted by the portable monitoring unit 200 corresponds to the unique user ID code stored in the mobile transmitter 100. If the ID codes are matched, the mobile transmitters 100 transmits the carrier signals 16a, 16b, 16c, 16d to the portable monitoring unit 200.

As described above, the GPS receiver circuit 246 of the portable monitoring unit 200 determines the geographical location of the mobile transmitter 100 and superimposes its location on a display screen 202 by reference to a database of maps stored on the portable monitoring unit 200. Displaying the location on the screen 202 of the portable monitoring unit 200 allows the user 14 to view the location of the mobile transmitter 100 (and consequently the subject 12) wherever the user 14 is located, especially if the user 14 is away from home and has no access to a computer system or detailed maps capable of displaying the location of the mobile transmitter 100 and adjacent local streets or other geographic features.

The portable monitoring unit 200 is able to transmit a “panic” signal to the mobile transmitter 100 when the user 14 depresses a “panic button” 204. In response to the panic button 204, the portable monitoring unit 200 transmits the panic signal to the mobile transmitter 100, which causes a speaker 102 on the mobile transmitter 100 to emit a high-decibel noise. This sound is intended to alert persons adjacent the subject 12 of a possible emergency situation, such as a lost child or kidnapping situation.

In accordance with another embodiment of the invention, described below, the system 10 may also include a cellular network 30 (See FIG. 1). According to this embodiment, the mobile transmitter 100 dials into to a cellular network 30 (signal 40) to transmit the ranging signals 16a, 16b, 16c, 16d. The cellular network 30, in turn, transmits the ranging signals 16a, 16b, 16c, 16d to the portable monitoring unit 200 (signal 50). The portable monitoring unit 200 may transmit the request signal to the cellular network 30 (signal 51), which in turn relays the request signal to the mobile transmitter (signal 41).

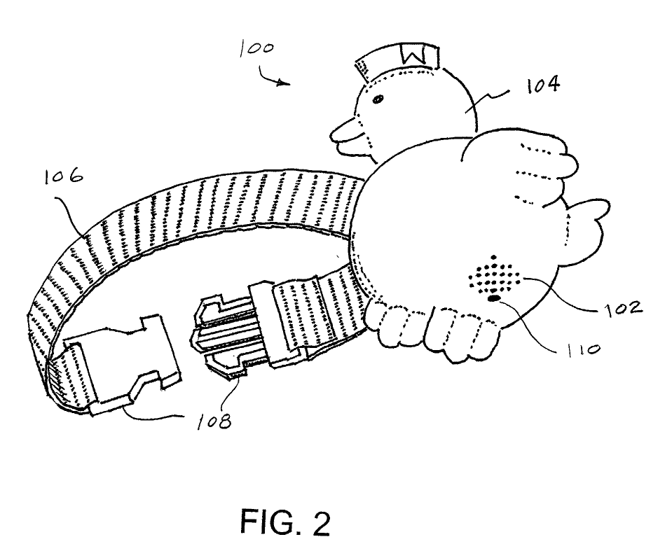

The mobile transmitter 100 is illustrated in greater detail in FIG. 2. The mobile transmitter 100 includes a case 104 and a strap 106 for removably securing the case 104 to the subject 12. In the exemplary embodiment, the mobile transmitter 100 is removably secured near the ankle of the subject 12 (see FIG. 1). Alternatively, the mobile transmitter 100 is secured the subject's wrist or waist. The mobile transmitter 100 is also capable of being secured to the subject's clothing or shoes or secured thereto by the use of clips or pins.

In the exemplary embodiment, the mobile transmitter 100 may be used for a young child, and the case 104 may be configured, as shown in FIG. 2, with an ornamental shape or surface detail. The case 104 may be molded of plastic or resin material, and is preferably waterproof. The strap 106 and clasp 108 are used to removably secure the mobile transmitter 100 to the subject 12. The strap 106 is fabricated from a flexible, durable material, such as leather, nylon, plastic, acrylic or rubber. The clasp unit 108 is attached to secure the free ends of the strap 106 together about the subject's ankle or wrist. The strap 106 is preferably adjustable in order to provide a secure fit. (It is noted that the clasp unit 108 may alternatively be a buckle or may incorporate a lock to prevent accidental opening of the clasp unit 108.) The clasp unit 108 may also incorporate childproof features to discourage the subject 12 from opening the clasp unit 108 and removing the mobile transmitter 100 without assistance from the adult user 14. The mobile transmitter 100 also incorporates a speaker unit 102, described above, which emits an audible signal when a panic button 204 is depressed on the portable monitoring unit 200. The speaker unit 102 and a microphone 110 provide the capability of two-way verbal communication between the subject 12 and the user 14 with the portable monitoring unit 200.

Additional features of the mobile transmitter 100 are illustrated in greater detail in FIG. 3. Power for the mobile transmitter 100 is supplied by a battery 112. The battery 112 is preferably a long life battery, such as a lithium or similar watch battery. It is also noted that the battery 112 may be a rechargeable battery. In such a case, a separate battery charger unit 114 may be supplied to recharge the battery 112, and is connected to the mobile transmitter 100 by terminals 116.

A GPS antenna 118 receives the GPS ranging signals 16a, 16b, 16c, 16d transmitted from the GPS SV's 18a, 18b, 18c, 18d positioned in the sky above the mobile transmitter 100 (see FIG. 1). GPS antenna 118 may be any GPS antenna configured for use in remote portable unit. GPS antenna models MK-4, which is a miniature GPS antenna, and RA-45, which is a re-radiating GPS antenna that allows the mobile transmitter 100 to receive the GPS ranging signals indoors, both of which are manufactured by San Jose Navigation, Inc., of Taipei, R.O.C., are useful for this application. As described above, at least three ranging signals are necessary for a GPS receiver to determine a geographical location. However, ranging signals from four SV's are preferable to correct possible timing errors, as is well known in the art. The GPS receiver circuit 120 receives the GPS signals 16a, 16b, 16c, 16d from the GPS antenna 118. GPS receiver 120 may be a simplified circuit which does not require position determination capability. A suitable GPS receiver circuit for this purpose is the REB-2000 series miniature GPS receiver circuit manufactured by Royaltek Company Ltd., of Tao Yuan City, R.O.C. GPS receiver 120 receives the GPS ranging signals and re-transmits them to the portable monitoring unit 200. No location determination calculations are performed by GPS receiver circuit 120.

Communication between the mobile transmitter 100 and the portable monitoring unit 200 may be performed by a radio transceiver 124 and radio antenna 126. Radio transceiver 124 and radio antenna 126 preferably operate on a VHF band. The radio transceiver 124 is configured to receive at least three types of signals from the portable monitoring unit 200. A first type of signal is a request signal which requests that the mobile transmitter 100 begin to transmit the ranging signals 16a, 16b, 16c, 16d. A second type of signal is speech communication from the user 14. A third type of signal is a panic signal.

The radio transceiver 124 is also configured to transmit two types of signals to the portable monitoring unit 200. The first signal is the GPS ranging signals 16a, 16b, 16c, 16d, and the second type of signal is speech communication from the subject 12. In another embodiment, radio transceiver 124 is replaced by up to four radio transceivers, such that one transceiver is dedicated to the reception of the request signal from the handheld monitoring unit 200, another transceiver is used for the transmission of GPS ranging signals to the handheld monitoring unit 200, a third transceiver is dedicated to reception of the panic signal, and a fourth transceiver is dedicated to the two-way speech communication.

The request signal transmitted from the portable monitoring unit 200 typically includes a unique user ID code to identify the particular mobile transmitter 100 to be located. Typically, a mobile transmitter 100/portable monitoring unit 200 will comprise a matched pair having the same unique user ID code. The unique user ID code for each mobile transmitter 100 is stored in memory 128, preferably a non-volatile memory, such as ROM. Typically, a decoder circuit 130 receives the request signal from the portable monitoring unit 200, and identifies an ID code being transmitted with the request signal. If the decoder circuit 130 determines that the ID codes match for the portable monitoring unit 200 and mobile transmitter 100, then the mobile transmitter 100 begins transmitting the ranging signals 16a, 16b, 16c, 16d by use of the radio transceiver 124 and radio antenna 126. Once the user ID code on the request signal has been identified, the mobile transmitter 100 will continue to broadcast the GPS ranging signals to the handheld monitoring unit to update the position of the mobile transmitter 100 (if it is moving), approximately once every minute.

Two-way speech communication may be provided between the mobile transmitter 100 and the portable monitoring unit 200 by use of the radio transceiver 124, operating on the same or a different frequency than the request signal. The signals containing the speech communication from the user 14 are received by the radio antenna 126 and the radio transceiver 124 and reproduced by the speaker unit 102. The subject 12 may respond by speaking into the microphone 110, and the subject's speech is subsequently transmitted by the radio transceiver 124.

When the portable monitoring unit 200 transmits the panic signal and the unique user ID code to the mobile transmitter 100, that panic signal is also received by the radio antenna 126 and the radio transceiver 124, causing the speaker 102 to emit a high decibel alarm signal if the ID codes match. The panic signal may be on the same or a different frequency than the request signal or the GPS SV signals.

According to another embodiment, the mobile transmitter is provided which performs certain functions described above, and may be manufactured at a lower cost. In particular, the mobile transmitter comprises a GPS antenna and a GPS receiver circuit, such as GPS antenna 188 and GPS receiver circuit 120 described above. The GPS antenna and GPS receiver circuit receive the GPS ranging signals, which are transferred to a radio transceiver and radio antenna, such as radio transceiver 124 and radio antenna 126, described above. In operation, the radio transceiver 124 would periodically transmit the GPS ranging signals to the handheld monitoring unit 200, where location determination would be performed. Power would be provided by a battery, such as battery 112, described above.

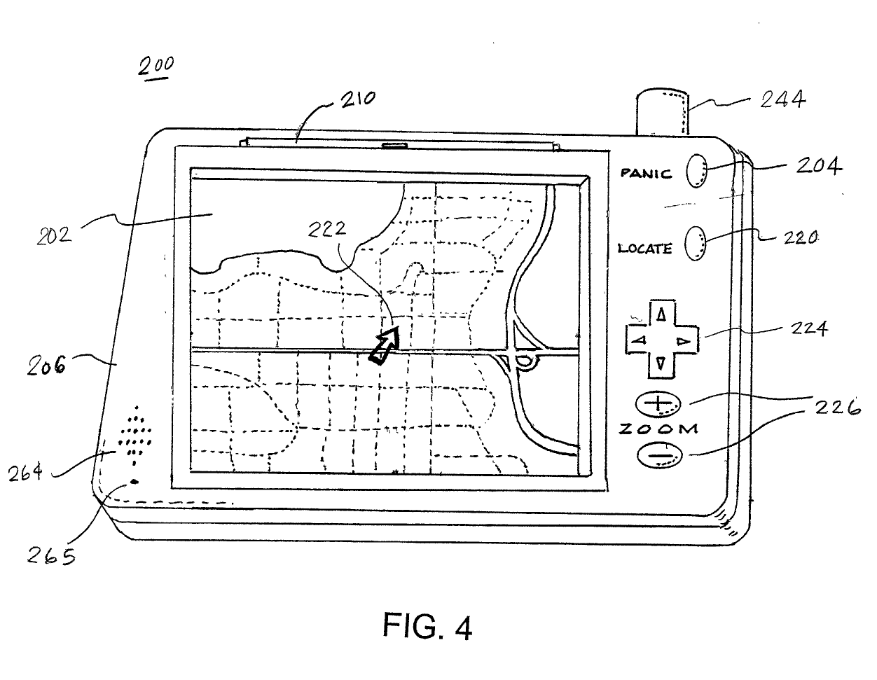

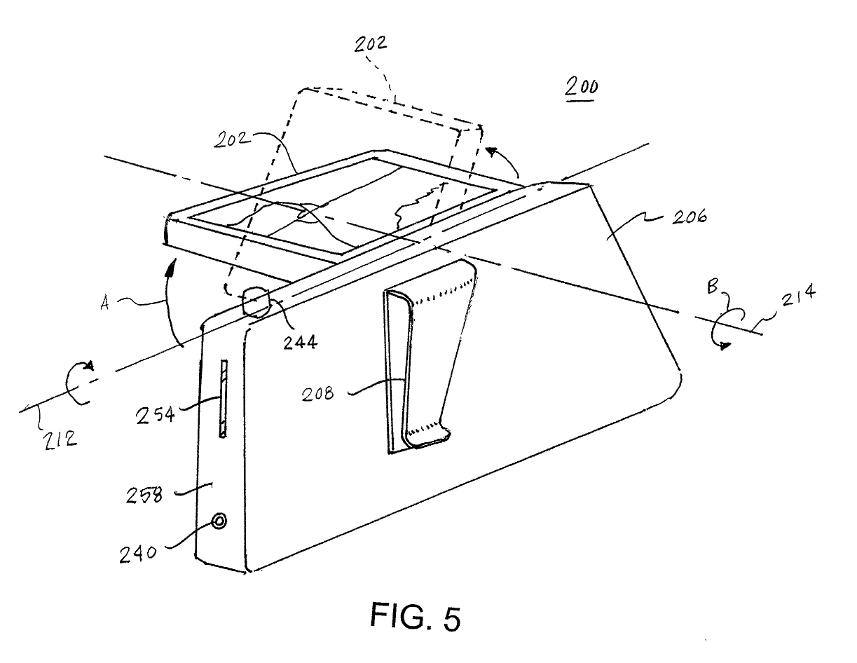

The portable monitoring unit 200 is illustrated in greater detail in FIGS. 4-5. The portable monitoring unit 200 includes a case 206 and a screen 202 for displaying the location of the mobile transmitter 100. In the exemplary embodiment, the portable monitoring unit 200 is portable and may be carried by the user 14 interested in monitoring the location of the mobile transmitter 100 (and consequently the subject 12). Thus, the case 206 is compact in dimensions and the entire portable monitoring unit 200 is lightweight. As illustrated in FIG. 5, the case 206 is provided with a clip 208 which allows the unit 200 to be secured to a belt of the user 14 or to the sun visor of a vehicle. The screen 202 is preferably a color LCD monitor having a hinged and pivotable mount 210 that allows the screen to be rotated through several degrees of freedom. For example, as illustrated in FIG. 5, the screen 202 is configured to rotate about axis 212 as indicated by arrow A. This permits the screen 202 to be viewed by the user 14 when the portable monitoring unit 200 is worn near the user's waist on a belt. In addition, the pivoting portion of the mount 210 (not visible in FIG. 4) permits the screen 202 to be pivoted about axis 214 as indicated by arrow B to the location denoted by dashed lines.

With continued reference to FIG. 4, the case 206 is provided with several user-accessible controls. A locate button 220, as will be described below, initiates the request signal to the mobile transmitter 100, which requests that the mobile transmitter 100 transmit the ranging signals 16a, 16b, 16c, 16d. When the GPS receiver circuit 246 (described below) determines the location of the mobile transmitter 100, the screen 202 displays its location by use of an indicator, such as a cursor 222. The streets and other geographical features adjacent the location are displayed on a map on screen 202. In order to scroll about the map on screen 202, a cursor control 224 is provided. In addition, zoom keys 226 allow the user 14 to magnify or reduce the map displayed on the screen 202. The panic button 204, described above, is provided on the case 206 and causes a panic signal to be transmitted to the mobile transmitter 100. The panic signal persists until the panic button 204 is released by the user 14. In an exemplary embodiment, the panic button 204 is provided with a detent. When the panic button 204 is first depressed, it is retained in the detent such that the panic signal continuously transmitted. When the panic button 204 is depressed again, it is released from the detent, and the panic signal is terminated.

Additional features of the portable monitoring unit 200 are illustrated in greater detail in FIG. 6. Power for the portable monitoring unit 200 is supplied by a battery 236. The battery 236 is preferably a long life battery, such as a lithium or similar watch battery. It is also noted that the battery 236 may be a rechargeable battery. In such a case, a separate battery charger unit 238 may be supplied to recharge the battery 236, and is connected to portable monitoring unit 200 by terminals 240. The portable monitoring unit 200 may also be used in an automobile, in which case the battery charger unit 238 may be replaced by an 12 V power source (not shown).

A radio transceiver 242, operating on a VHF band, receives the signals transmitted from the mobile transmitter 100 by use of a radio antenna 244. As described above, the mobile transmitter 100 relays the ranging signals 16a, 16b, 16c, 16d. The GPS receiver circuit 246 computes the geographical location of the mobile transmitter 100 by the process of trilateration. The GPS receiver circuit 246 relies on an almanac, preferably stored in a database in memory 248, that indicates the location of each one of the GPS SV's 18a, 18b, 18c, 18d at a given time. The information in the almanac is updated is periodically updated in the navigation message of the ranging signals 16a, 16b, 16c, 16d.

The GPS receiver circuit 246 processes the ranging signal received by the mobile transmitter 100. As described above, each of the ranging signals 16a, 16b, 16c, 16d received by the mobile transmitter 100 has an offset (delay) indicative of the distance of each GPS SV from the mobile transmitter 100. The offsets of each of the ranging signals uniquely determines the location of the mobile transmitter 100. When the ranging signals are re-transmitted to the monitoring unit 200, the offset information unique to the location of the mobile transmitter 100, is preserved. The GPS receiver 246 identifies the particular GPS SV 18a, 18b, 18c, 18d from its unique ranging signal. The GPS receiver circuit 246 generates a replica C/A code for that particular GPS SV, synchronized to GPS time. The phase by which the replica code must be shifted in the GPS receiver 246 to maintain maximum correlation with the C/A code transmitted by the SV, multiplied by the speed of light, is approximately equal to the distance of the GPS SV from the remote receiver 100, prior to corrections for atmospheric effects, etc. Once the distances of each of the GPS SV's is determined, and the position of each of the SV's is known from the almanac stored in memory 248, the GPS receiver circuit 246 computes the location of the mobile transmitter 100. Several GPS circuits on the market would be useful for this purpose. For example, the FV-12 GPS receiver module, manufactured by San Jose Navigation of Taipei, R.O.C. may be used to perform the functions described herein. Another useful GPS circuit is the GPS-25 LVC GPS engine, manufactured by GARMIN International Inc., of Olathe, Kans.

Operation of the GPS receiver circuit 246 with other components of the portable monitoring unit 200 may be controlled by a microprocessor 250. In some cases, the GPS receiving circuit 246, memory 248, and the microprocessor 250 may be on a single integrated circuit. The microprocessor 250 may also be programmed to control the communications between the portable monitoring unit 200 and the mobile transmitter 100, and to control the user inputs at the portable monitoring unit 200.

After the GPS receiving circuit 246 has determined the location of the mobile transmitter 100, this location is displayed on the screen 202. A database 252 stores a series of detailed maps, preferably in WGS 84 format, which include local streets and geographical features. Such detail is helpful to particularly locate the mobile transmitter 100 (and consequently the subject 12), particularly if the subject is a young child. The microprocessor 250 is programmed to obtain the location coordinates from the GPS receiver circuit 246, and a map containing the location coordinates from database 252. The microprocessor is also programmed to control the display of the map and the mobile transmitter location on the screen 202. The geographical features which are stored in database 252 are subject to change over time, and render the database obsolete. Moreover, the subject 12 and the user 14 may change location from the region covered by the database 252, e.g., by relocating or by travelling on vacation. Therefore, the portable monitoring unit 200 is provided with a cartidge slot 254 for receiving a data cartridge 256 containing additional detailed maps, e.g., Compact Flash cards, or any similar format. A data port 258 (serial, USB, etc.) is also provided which allows the database 252 to be updated by downloading information from a computer 260. The computer 260 may access map databases from a CD-ROM, a local area network, or the World Wide Web.

An input keypad 262 allows the user 14 to provide inputs to the portable monitoring unit 200 as described above with respect to FIG. 4. More particularly, the panic button 204, the locate button 220, the zoom control 226, and the cursor control 224 (which includes inputs in two directions, i.e., horizontal and vertical) are provided at the input keypad 262, which in turn provide signals to the microprocessor 250. A speaker/microphone unit 264 allows two-verbal communication with the mobile transmitter 100, as described above. A headphone jack 270 is also provided on the unit 200, which allows a set of headphones 272 (see, FIG. 6)

As described above with respect to the mobile transmitter 100, there are three types of signals transmitted by the portable monitoring unit 200, i.e., the request signal, the panic signal, and verbal communication from the user 14. The request signal is transmitted by the portable monitoring unit 200 by the radio transceiver 242, in response to pressing the locate button 220. The request signal includes the unique user ID code which is stored in memory 268, preferably in non-volatile memory, such as ROM. The microprocessor 250 is programmed to receive a locate command from button 220, and to obtain the unique user ID code from memory 268, and transmit the request signal with radio transceiver 242 and radio antenna 244.

The portable monitoring unit 200 transmits the panic signal to the mobile transmitter 100 by use of the radio transceiver 242, in response to panic button 204 being depressed. In the same manner as with the request signal, the microprocessor 250 is programmed to receive a panic command from button 204, and to obtain the unique user ID code from memory 268, and transmit the panic signal with radio transceiver 242 and radio antenna 244. Verbal communication is transmitted to the mobile transmitter 100 by use of the radio transceiver 242, in response to verbal signals being received by the microphone 265.

The operation of the system 10 in accordance with the invention will now be described. The mobile transmitter 100 is secured to the subject 12 with the strap 106 and clasp 108, and the user 14 carries the portable monitoring unit 200. The mobile transmitter 100 receives the ranging signals 16a, 16b, 16c, 16d from the GPS SV's 18a, 18b, 18c, 18d. When the user 14 requests the location of the mobile transmitter 100, the locate button 220 is depressed. The radio transceiver 242 transmits the unique user ID code, which is received by the radio antenna 126 and radio transceiver 124. If the ID codes between the mobile transmitter 100 and the portable monitoring unit 200 match, the radio transceiver 124 begins to relay the ranging signals 16a, 16b, 16c, 16d to the portable unit 200. The GPS receiving circuit 246 of the portable monitoring unit 200 calculates the location of the mobile transmitter 100 from the ranging signals and displays its location on the screen 202.

The user 14 of the portable monitoring unit 200 may initiate a panic signal by depressing the panic button 204. The panic signal is received by the radio transceiver 124 and a high-decibel blast is emitted by the speaker 102 of the mobile transmitter.

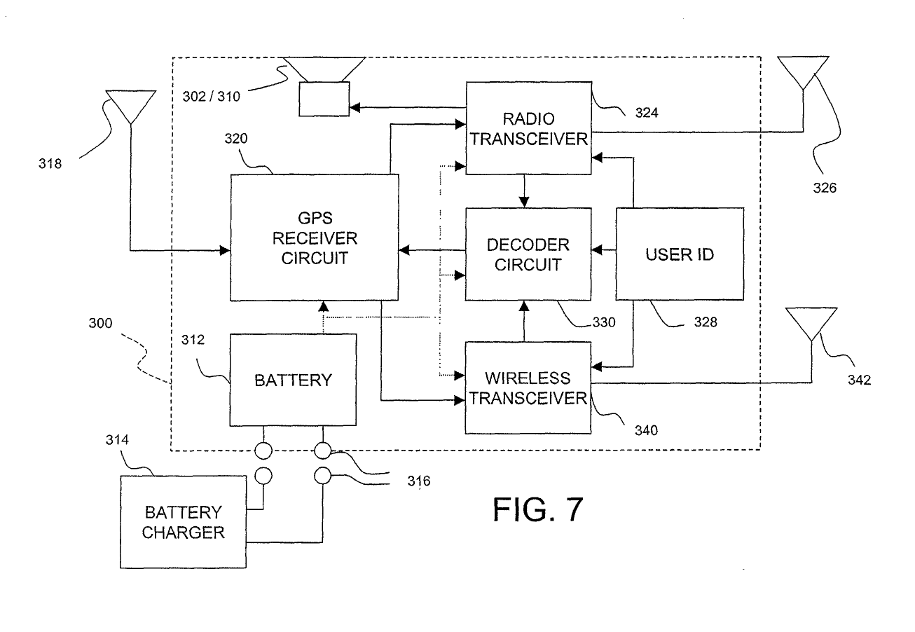

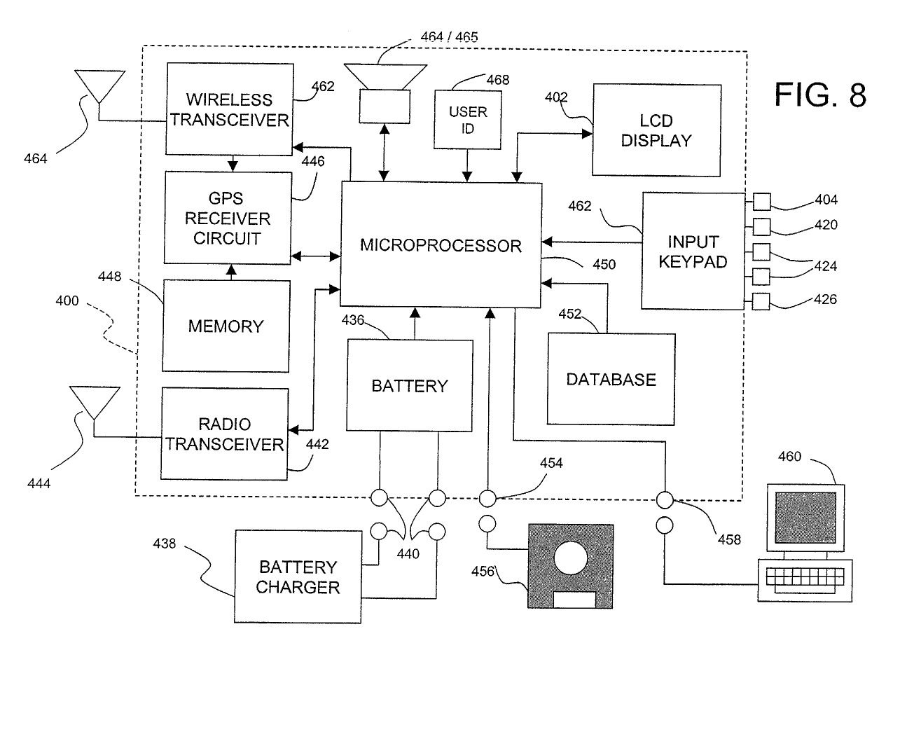

Another embodiment of the invention is illustrated in FIGS. 7 and 8. Mobile transmitter 300 and portable monitoring unit 400 are substantially identical to mobile transmitter 100 and portable monitoring unit 200, respectively, with the following differences as noted herein. Mobile transmitter 300 and portable monitoring unit 400 communicate with each using a wireless cellular network 30 rather than radio frequency communications, as with mobile transmitter 100 and portable monitoring unit 200, described above. More particularly, the communication of the request signal from the portable monitoring unit 200 to the mobile transmitter 100, the communication of the GPS ranging signals from the mobile transmitter 100 to the portable monitoring unit 200 are transmitted over the cellular network 30. The communication of the panic signal from the portable monitoring unit 200 to the mobile transmitter 100 and the two-way verbal communication are performed over a radio frequency.

Mobile transmitter 300 is illustrated in FIG. 7. Radio transmitter 300 is substantially identical to radio transmitter 100, described above. Radio transmitter 300 also includes a wireless transceiver 340 and wireless antenna 342. As is known in the art, wireless transceiver 340 is programmed to transmit and receive wireless communications from a cellular network 30 (FIG. 1). For example, wireless transceiver 340 is programmed to acknowledge a request signal from the portable monitoring unit 400, by transmitting the GPS signals received from the three or four adjacent GPS SV's. Wireless transceiver 340 may be programmed with a unique wireless telephone number and a unique user ID code stored in memory 328. When the wireless connection is made, the wireless transceiver 340 begins to transmit the GPS signals. Radio transceiver 324 receives the panic signal and transmits and receives the two-way verbal communication.

Portable monitoring unit 400 is illustrated in FIG. 8. Portable monitoring unit 400 is substantially identical to portable monitoring unit 200, described above. Portable monitoring unit 400 also includes a wireless transceiver 462 and wireless antenna 464. As is known in the art, wireless transceiver 462 is programmed to transmit and receive wireless communications from a cellular network 30 (FIG. 1). For example, wireless transceiver 462 is programmed to transmit a request signal to the mobile transmitter 300. In order to dial into the wireless network 30, wireless transceiver 462 may be programmed to dial a predetermined number and to supply the unique user ID code stored in memory 468. When the wireless connection is made, the wireless transceiver 462 begins to transmit the request signal. Radio transceiver 442 transmits the panic signal when panic button 404 is depressed and transmits and receives the two-way verbal communication, as described above with respect to portable monitoring apparatus 200.

It will be understood that the foregoing is only illustrative of the principles of the invention, and that various modifications can be made by those skilled in the art without departing from the scope and spirit of the invention.

What is claimed is:

1. A system for monitoring the location of a person, comprising:
(a) a mobile transmitter configured to be removably secured to the person, comprising a GPS antenna configured to receive a plurality of GPS ranging signals from GPS satellites, a first GPS receiver circuit configured to identify the GPS ranging signals, and a first transceiver and a first antenna configured to re-transmit the GPS ranging signals;
(b) a portable monitoring unit comprising a portable case, a second transceiver and a second antenna configured to receive the GPS ranging signals from the mobile transmitter, a second GPS receiver circuit configured to receive GPS ranging signals from the mobile transmitter and to determine the location of the mobile transmitter and a display screen configured to superimpose the location of the mobile transmitter on a local area map.

2. The system of claim 1, wherein the first antenna, the first transceiver, the second antenna, and the second transceiver are configured to operate on a radio frequency, and wherein the re-transmitted GPS ranging signals are transmitted on a radio frequency.

3. The system of claim 2, wherein the portable monitoring unit further comprises a first button, which actuates the second transceiver and the second antenna to broadcast a second radio frequency signal to the mobile transmitter, and wherein the mobile transmitter comprises a speaker configured to produce a high-decibel sound when the second radio frequency signal is received by the first antenna and the first transceiver.

4. The system of claim 3, wherein the portable monitoring unit comprises a first microphone, and the second transceiver and the second antenna are configured to broadcast a third radio frequency signal corresponding to sounds received by the microphone, and wherein the first antenna and the first transceiver of the mobile transmitter are configured to receive the third radio frequency signal and produce a signal supplied to the first speaker, which is configured to reproduce the sounds received by the first microphone.

5. The system of claim 4, wherein the mobile transmitter comprises a second microphone, and the first transceiver and the first antenna are configured to broadcast a fourth radio frequency signal corresponding to sounds received by the second microphone, and wherein the portable monitoring unit further comprises a second speaker, and the second antenna and the second transceiver are configured to receive the fourth radio frequency signal and produce a signal supplied to the second speaker, which is configured to reproduce the sound received by the second microphone.

6. The system of claim 5, wherein the portable monitoring unit comprises a headphone jack and the second speaker is located in a pair of headphones connected to the headphone jack.

7. The system of claim 1, wherein the first antenna, the first transceiver, the second antenna, and the second transceiver are configured to operate on a cellular telephone network, and wherein the GPS ranging signals are re-transmitted on the cellular telephone network.

8. The system of claim 7, wherein the mobile transmitter further comprises a third transceiver, a third antenna, and a third speaker, and the portable monitoring unit further comprises a fourth transceiver, a fourth antenna, and an input switch, which actuates the fourth transceiver and the fourth antenna to broadcast a radio frequency signal to the mobile transmitter, and wherein the speaker is configured to produce a high-decibel sound when the radio frequency signal is received by the third antenna and the third transceiver.

9. The system of claim 1, wherein the mobile transmitter further comprises a waterproof case.

10. The system of claim 1, wherein the portable monitoring unit further comprises a database for storing local area maps.

11. The system of claim 10, wherein the portable monitoring unit further comprises an input device for downloading maps onto the database.

12. The system of claim 11, wherein the input device is a dataport for downloading maps from a computer.

13. The system of claim 10, wherein the portable monitoring unit has a cartridge slot for receiving a data cartridge storing maps.

14. The system of claim 1, wherein the display screen is an LCD panel.

15. The system of claim 1, wherein the display screen is pivotably mounted with respect to the portable case.

16. A system for monitoring the location of a person, comprising:
(a) a mobile transmitter configured to be removably secured to the person, comprising a GPS antenna configured to receive a plurality of GPS ranging signals from GPS satellites, a GPS receiver circuit configured to identify the GPS ranging signals, a memory unit storing a first identification code, and a first transceiver and a first antenna;
(b) a portable monitoring unit comprising a portable case, a memory unit storing a second identification code, a second transceiver and a second antenna configured to transmit a request signal comprising the second identification code and to receive the GPS ranging signals from the mobile transmitter, a GPS receiver circuit configured to receive GPS ranging signals from the mobile transmitter and to determine the location of the mobile transmitter and a display screen configured to superimpose the location of the mobile transmitter on a local area map;
wherein the first transceiver and the first antenna are configured to receive the request signal comprising the second identification code and to re-transmit the GPS ranging signals to the portable monitoring unit if the first identification code matches the second identification code.

17. The system of claim 16, wherein the first antenna, the first transceiver, the second antenna, and the second transceiver are configured to operate on a radio frequency, and wherein the re-transmitted GPS ranging signals and the request signals are transmitted on a radio frequency.

18. The system of claim 17, wherein the portable monitoring unit further comprises a first button, which actuates the second transceiver and the second antenna to broadcast a second radio frequency signal to the mobile transmitter, and wherein the mobile transmitter comprises a speaker configured to produce a high-decibel sound when the second radio frequency signal is received by the first antenna and the first transceiver.

19. The system of claim 18, wherein the portable monitoring unit comprises a microphone, and the second transceiver and the second antenna are configured to broadcast a third radio frequency signal corresponding to sounds received by the microphone, and wherein the first antenna and the first transceiver of the mobile transmitter are configured to receive the third radio frequency signal and produce a signal supplied to the speaker, which is configured to reproduce the sounds received by the microphone.

20. The system of claim 19, wherein the mobile transmitter comprises a second microphone, and the first transceiver and the first antenna are configured to broadcast a fourth radio frequency signal corresponding to sounds received by the second microphone, and wherein the portable monitoring unit further comprises a second speaker, and the second antenna and the second transceiver are configured to receive the fourth radio frequency signal and produce a signal supplied to the second speaker, which is configured to reproduce the sound received by the second microphone.

21. The system of claim 16, wherein the first antenna, the first transceiver, the second antenna, and the second transceiver are configured to operate on a cellular telephone network, and wherein the re-transmitted GPS ranging signals and the request signals are transmitted on the cellular telephone network.

22. The system of claim 21, wherein the mobile transmitter further comprises a third transceiver, a third antenna, and speaker, and the portable monitoring unit further comprises a fourth transceiver, a fourth antenna, and an input switch, which actuates the fourth transceiver and the fourth antenna to broadcast a radio frequency signal to the mobile transmitter, and wherein the speaker is configured to produce a high-decibel sound when the radio frequency signal is received by the third antenna and the third transceiver.

23. The system of claim 16, wherein the mobile transmitter comprises a waterproof case.

24. A method for monitoring the location of a person, comprising:
(a) providing a mobile transmitter removably secured to the person and a portable monitoring unit at a location remote from the mobile transmitter;
(b) receiving GPS ranging signals at the mobile transmitter, the GPS ranging signals each comprising an offset corresponding to the distance of the mobile transmitter from the respective GPS satellite broadcasting the GPS ranging signals;
(c) re-transmitting the GPS ranging signals including the respective offsets to the portable monitoring unit;
(d) determining, at the portable monitoring unit, coordinates of the mobile transmitter from the GPS ranging signals and their respective offsets; and
(e) superimposing, at the portable monitoring unit, the coordinates of the first location on a map.

25. The method for monitoring the location of a person of claim 24, wherein prior to step (c), further comprising transmitting a request signal from the portable monitoring unit to the mobile transmitter, and step (c) further comprises re-transmitting the GPS ranging signals including the respective offsets to the portable monitoring unit upon receipt of the request signal.
